(19) United States
(12) Patent Application Publication
(10) Pub. No.: US 2014/0326776 A1
(43) Pub. Date: Nov. 6, 2014

(54) DRIVING-IN APPARATUS

(71) Applicant: Hilti Aktiengsesellschaft, Schaan (LI)

(72) Inventors: Reinhard Riedl, Finning (DE); Joerg Stamm, Buchs SG (CH); Ulrich Schiestl, Hohenems (AT)

(21) Appl. No.: 14/366,182

(22) PCT Filed: Nov. 7, 2012
(86) PCT No.: PCT/EP2012/072012

§ 371 Date: Jun. 17, 2014

(30) Foreign Application Priority Data
Dec. 23, 2011 (DE) 102011089860.3

(51) Int. Cl. B25C 1/00

(52) U.S. Cl. CPC B25C 1/00
USPC 227/146

(57) ABSTRACT

According to one aspect of the application, an apparatus for driving a fixing element into a substrate having an energy transfer element to transfer energy to the fixing element. Preferably, the energy transfer element is movable between a starting position and a set position, whereby the energy transfer element is in the starting position before the driving-in operation and in the set position after the driving-in operation.

According to a further aspect of the application, the apparatus has a mechanical energy storage device to store mechanical energy. It is then preferred for the energy transfer element to transfer energy from the mechanical energy storage device to the fixing element.

### TECHNICAL SCOPE

The application relates to an apparatus for driving a fixing element into a substrate.

### STATE OF THE ART

Such apparatuses typically include a piston to transfer energy to the fixing element. The energy required for this purpose has to be made available within a very short time, which is why, for example, in so-called spring nailers a spring is first tensioned and then suddenly transfers the tensioning energy to the piston, and accelerates the latter towards the fixing element during the driving-in operation.

The energy with which the fixing element is driven into the substrate is limited in the case of the above-mentioned kind of apparatuses, so the apparatus cannot be used for all fixing elements and all substrates. It is therefore desirable to provide driving-in apparatuses that can transfer sufficient energy to a fixing element.

### SUMMARY OF THE INVENTION

According to one aspect of the application, an apparatus for driving a fixing element into a substrate has a mechanical energy storage device for storing the mechanical energy and a movable energy transfer element moving along a set axis between a starting position and a set position in order to transfer energy from the mechanical energy storage device to the fixing element, whereby the mechanical energy storage device includes a first coil spring, whose helix defines a cylinder whose volume is arranged outside the set axis.

A preferred embodiment is characterized in that the axis of symmetry of the cylinder extends parallel to the set axis.

A preferred embodiment is characterized in that the energy transfer element is arranged at the same height as the first coil spring in the starting position and/or in the set position in the axial direction.

A preferred embodiment is characterized in that the mechanical energy storage device has one or more additional coil springs, the helixes of which each define a cylinder whose volume is arranged outside the set axis.

A preferred embodiment is characterized in that the first and any additional coil springs are uniformly distributed around the set axis.

In a preferred embodiment, the apparatus has a force receiving element, in particular a roller holder, to receive the tensioning force of the first and at least one other coil spring.

In a preferred embodiment, the apparatus has a guide for the force receiving element.

A preferred embodiment is characterized in that the force receiving element is provided with an especially resilient compensation element for the first coil spring and/or the additional coil spring.

A preferred embodiment is characterized in that the first coil spring is coiled in a first direction of rotation, while the additional coil spring is coiled in a second direction of rotation opposite to that of the first direction of rotation. In this way, the negative effects of the directions of rotation may be compensated under certain circumstances.

In a preferred embodiment, the device has an energy transfer device for the transfer of energy from an energy source to the mechanical energy storage device.

In a preferred embodiment, the device has a force transfer device to transfer force from the energy transfer device to the mechanical energy storage device and/or to transfer force from the energy storage device to the energy transfer device.

A preferred embodiment is characterized in that the force transfer device has a force deflector to deflect the direction of the force transferred from the force transfer device.

A preferred embodiment is characterized in that the force deflector has a belt.

A preferred embodiment is characterized in that the force deflector extends from the inside the helix of the first and/or additional coil spring.

A preferred embodiment is characterized in that the energy transfer device has a movement transducer to convert rotary movement into linear movement by means of a rotary drive and a linear drive, whereby the movement transducer is arranged on the set axis.

In a preferred embodiment, the device has a coupling device for temporarily retaining the energy transfer element in the starting position, whereby the coupling device is arranged on the set axis.

In a preferred embodiment, the device has a tie rod for the transfer of a pulling force from the energy transfer device, particularly the linear drive and/or the rotary drive to the coupling device, whereby the tie rod is arranged on the set axis.

A preferred embodiment is characterized in that the force transfer device, especially the force deflector, especially the belt on the energy transfer device, is attached in particular to the linear drive.

A preferred embodiment is characterized in that the energy transfer device is suitable for the conveyance of the energy transfer element from the set position to the starting position.

According to one aspect of the application, an apparatus for driving a fixing element into a substrate has a mechanical energy storage device for storing mechanical energy and an energy transfer device to transfer energy from an energy source to the mechanical energy storage device, whereby the energy transfer device has a first energy supply device to transfer energy from an energy source to the mechanical energy storage device and a second energy supply device that is different from the first energy supply device to transfer energy from the energy source to the mechanical energy storage device.

In a preferred embodiment, the apparatus has an energy transfer element which is movable along a set axis between a starting position and a set position in order to transfer energy from the mechanical energy storage device to the fixing element.

A preferred embodiment is characterized in that the energy transfer device has a force transfer device to transfer force from the energy storage device to the energy transfer element and/or to transfer force from the energy transfer device, in particular the first and/or second energy supply device, to the mechanical energy storage device.

A preferred embodiment is characterized in that the energy transfer device has a force deflector, whereby in particular the force deflector has a belt or a cable.

A preferred embodiment is characterized in that the first energy supply device is suitable for the conveyance of the energy transfer element from the set position to the starting position.

A preferred embodiment is characterized in that the second energy supply device is suitable to transfer energy to the mechanical energy storage device and/or conduct energy away from the mechanical energy storage device, without moving the energy transfer element.

A preferred embodiment is characterized in that the energy transfer device has an entrainment element that can be brought into engagement with the energy transfer element in order to move the energy transfer element from the set position to the starting position.

A preferred embodiment is characterized in that the energy transfer device has a motor with a motor drive, whereby in particular the motor is a component part of the first and second energy supply device.

A preferred embodiment is characterized in that the energy transfer device has a torque transfer device to transfer torque from the motor output, whereby in particular the torque transfer device is a component part of the first and second energy supply device.

A preferred embodiment is characterized in that the torque transfer device has a gear with a gear drive, a first gear output and a second gear output, whereby in particular the first gear output is a component part of only the first energy supply device, the second gear output is a component part of only the second energy supply device, while the gear drive is a component part of the first and the second energy supply device.

A preferred embodiment is characterized in that the gear has a planetary gear, whereby in particular the gear drive is formed by a sun wheel of the planetary gear, the first gear output is formed by a ring wheel of the planetary gear, and the second gear output is formed by a planetary wheel of the planetary gear.

A preferred embodiment is characterized in that the first and/or the second gear output has a parking brake and/or a freewheel.

A preferred embodiment is characterized in that the first energy supply device has a movement transducer to convert a rotary movement into a linear movement with a rotary drive driven by the motor and a linearly movable linear drive, whereby in particular the rotary drive is formed by the first gear output.

A preferred embodiment is characterized in that the rotary drive has a toothed wheel and the linear drive has a toothed rack.

A preferred embodiment is characterized in that the linear drive has the entrainment element.

A preferred embodiment is characterized in that the energy transfer element can be linearly driven by the linear drive or forms the linear drive.

A preferred embodiment is characterized in that the force transfer device has a take-up reel for winding up the force deflector, whereby the take-up reel for the transfer of energy to the mechanical energy storage device can be driven from the second energy supply device, in particular from the second gear output.

A preferred embodiment is characterized in that the mechanical energy storage device is provided in order to store potential energy, and in particular has a spring, in particular a coil spring.

A preferred embodiment is characterized in that two—in particular mutually opposite—ends of the spring are movable in order to tension the spring.

A preferred embodiment is characterized in that the spring has two spring elements spaced apart from one another which are in particular mutually supported.

According to one aspect of the application, an apparatus for driving a fixing element into a substrate along a set axis between a starting position and a set position has a movable energy transfer element to transfer energy to the fixing element and an energy transfer device for the conveyance of the energy transfer element from the set position to the starting position, whereby the energy transfer device has an entrainment spring and an entrainment element which can be engaged with the energy transfer element in order to move the energy transfer element from the set position to the starting position and which is reset by a force of the entrainment spring prior to a movement of the energy transfer device from the starting position to the set position.

A preferred embodiment is characterized in that the entrainment element is movable during resetting by means of the force of the entrainment spring at a higher speed than during the movement of the energy transfer device from the set position to the starting position.

A preferred embodiment is characterized in that the entrainment element is to be moved against the resetting force of the entrainment spring in order to move the energy transfer element from the set position into the starting position.

In a preferred embodiment, the apparatus has a mechanical energy storage device to store mechanical energy, whereby in particular the mechanical energy storage device is a potential energy storage device and is in particular formed as a spring.

A preferred embodiment is characterized in that the conveyance of the energy transfer element from the set position to the starting position serves to transfer energy to the mechanical energy storage device.

A preferred embodiment is characterized in that the apparatus comprises a coupling device for the temporary retention of the energy transfer element in the starting position, whereby the coupling device for the temporary retention of the energy transfer element is only suitable in particular in the starting position.

A preferred embodiment is characterized in that the coupling device is arranged on the set axis, or essentially symmetrically around the set axis.

A preferred embodiment is characterized in that the entrainment element can be reset by the force of the entrainment spring, while the energy transfer element is held in the starting position by the coupling device.

A preferred embodiment is characterized in that the entrainment element only abuts the energy transfer element.

A preferred embodiment is characterized in that the entrainment element has a longitudinal body, in particular a rod.

A preferred embodiment is characterized in that the energy transfer device has a linearly movable linear output, which comprises the entrainment element and is connected to the force transfer device.

According to one aspect of the application, an apparatus for driving a fixing element into a substrate has a mechanical energy storage device for storing mechanical energy and an energy transfer device to transfer energy from an energy source to the mechanical energy storage device, whereby the energy transfer device has a tensioning element which is movable between a relaxed position and a tensioned position, whereby the tensioning element is movable at a higher speed along the path from the tensioned position to the relaxed position than along the path from the relaxed position to the tensioned position.

A preferred embodiment is characterized in that the tensioning element for the transfer of energy to the mechanical energy storage device can be moved from the relaxed position to the tensioned position.

A preferred embodiment is characterized in that the energy transfer device has a motor for driving the tensioning element.

A preferred embodiment is characterized in that when driving the tensioning element along the path from the tensioned position to the relaxed position, the motor moves it at the same speed as when driving of the tensioning element along the path from the relaxed position to the tensioned position.

A preferred embodiment is characterized in that the energy transfer device has a coupling gear with a coupling gear drive and a coupling gear output, whereby the coupling gear output drives or forms the tensioning element.

A preferred embodiment is characterized in that the coupling gear drive can be driven by the motor.

A preferred embodiment is characterized in that the tensioning element can be moved back and forth linearly between the relaxed position and the tensioned position.

In a preferred embodiment, the apparatus has an energy transfer element movable along a set axis between a starting position and a set position to transfer energy from the mechanical energy storage device to the fixing element.

A preferred embodiment is characterized in that the energy transfer element is conveyed from the set position to the starting position when the tensioning element is moved from the relaxed position to the tensioned position.

A preferred embodiment is characterized in that the energy transfer element is conveyed from the set position to the starting position when the tensioning element is moved from the tensioned position to the relaxed position.

A preferred embodiment is characterized in that the energy transfer device has an entrainment element moved by the tensioning element or comprising a tensioning element which can be engaged with the energy transfer element in order to move the energy transfer element from the set position to the starting position.

A preferred embodiment is characterized in that the entrainment element is reset when the tensioning element is moved from the relaxed position to the tensioned position.

A preferred embodiment is characterized in that the entrainment element is reset when the tensioning element is moved from the tensioned position to the relaxed position.

A preferred embodiment is characterized in that the mechanical energy storage device is provided in order to store potential energy, and in particular has a spring, particularly a coil spring.

According to one aspect of the application, an apparatus for driving a fixing element into a substrate has an energy transfer element to transfer energy to the fixing element. Preferably, the energy transfer element is movable between a starting position and a set position, whereby the energy transfer element is in the starting position prior to a driving-in operation and is in the set position after the driving-in operation.

According to one aspect of the application, the apparatus has a mechanical energy storage device to store mechanical energy. The energy transfer element is then suitable for the transfer of energy from the mechanical energy storage device to the fixing element.

According to one aspect of the application, the apparatus has an energy transfer device to transfer energy from an energy source to the mechanical energy storage device. Preferably, the energy for a driving-in operation is cached in the mechanical energy storage device in order to be delivered instantly to the fixing element. Preferably, the energy transfer device is suitable for the conveyance of the energy transfer element from the set position to the starting position. Preferably, the energy source is an electrical energy storage device, most preferably a battery or a rechargeable battery. Preferably, the apparatus has the power source.

According to one aspect of the application, the energy transfer device is suitable to convey the energy transfer element from the set position in the direction of the starting position without energy in the mechanical energy storage device. This makes it possible for the mechanical energy storage device to absorb and/or discharge energy without moving the energy transfer element to the set position. The energy storage device can therefore be discharged without a fixing element being driven out of the apparatus.

According to one aspect of the application, the energy transfer device is suitable to transfer energy to the mechanical energy storage device without moving the energy transfer element.

According to one aspect of the application, the energy transfer device has a force transfer device to transfer force from the energy storage device to the energy transfer element and/or to transfer force from the energy transfer device to the mechanical energy storage device.

According to one aspect of the application, the energy transfer device has an entrainment element which can be engaged with the energy transfer element in order to move the energy transfer element from the set position to the starting position.

Preferably, the entrainment element allows a movement of the energy transfer element from the starting position to the set position. In particular, the entrainment element only abuts the energy transfer element, so that the entrainment element entrains the energy transfer element only in one of two opposing set directions of movement.

According to one aspect of the application, the energy transfer device has an energy supply device to transfer energy from an energy source to the mechanical energy storage device, and a return motion device that is separate from the energy supply device and that especially works independently for the conveyance of the energy transfer element from the set position to the starting position.

According to one aspect of the application, the apparatus has a coupling device for the temporary retention of the energy transfer element in the starting position. Preferably, the coupling device for temporarily holding the energy transfer element is only suitable in the starting position.

According to one aspect of the application, the apparatus has an energy transfer device with a linearly movable linear drive to convey the energy transfer element from the set position to the starting position on the coupling device.

Preferably, the energy transfer element consists of a rigid body.

According to one aspect of the application, the apparatus has a coupling device to temporarily hold the energy transfer element in the starting position and a tie rod to transfer a tensile force from the energy transfer device, in particular the linear output and/or the rotary drive to the coupling device.

According to one aspect of the application, the energy transfer element furthermore has a coupling plug part for temporary coupling to a coupling device.

According to one aspect of the application, the apparatus has a delay element to delay the energy transfer element. Preferably, the delay element has a stop surface for the energy transfer element.

According to one aspect of the application, the apparatus has an energy source.

According to one aspect of the application, the energy source is formed by an electrical energy storage device.

### EXAMPLES OF EMBODIMENTS

Hereinafter, embodiments of an apparatus for driving a fixing element into a substrate is described in detail by means of examples with reference to the drawings. The drawings show:

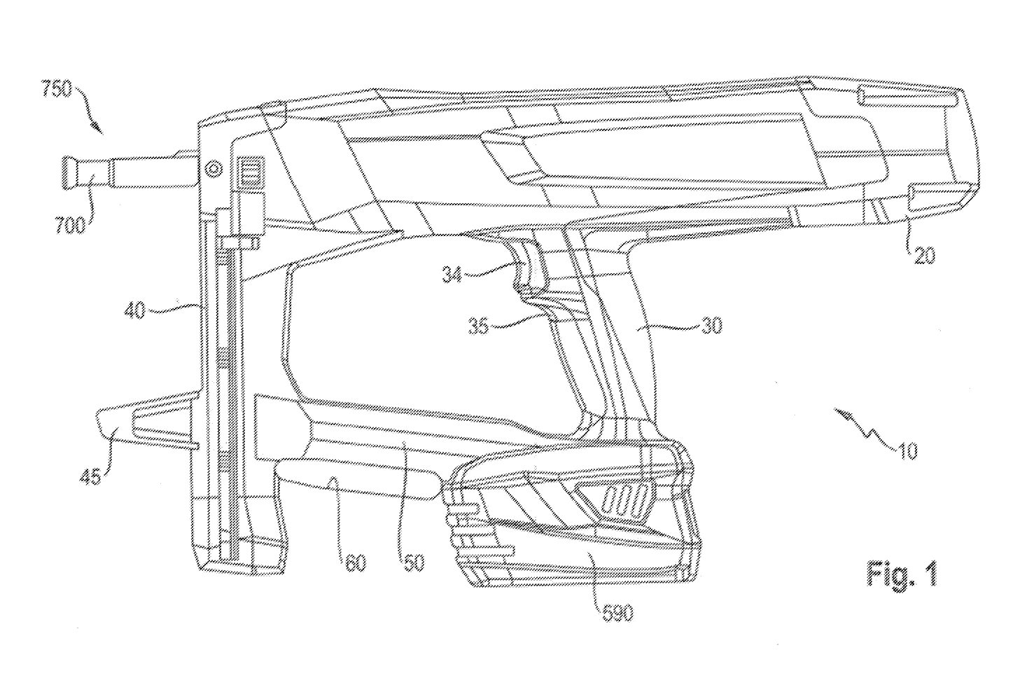

FIG. 1 a side view of a driving-in device,

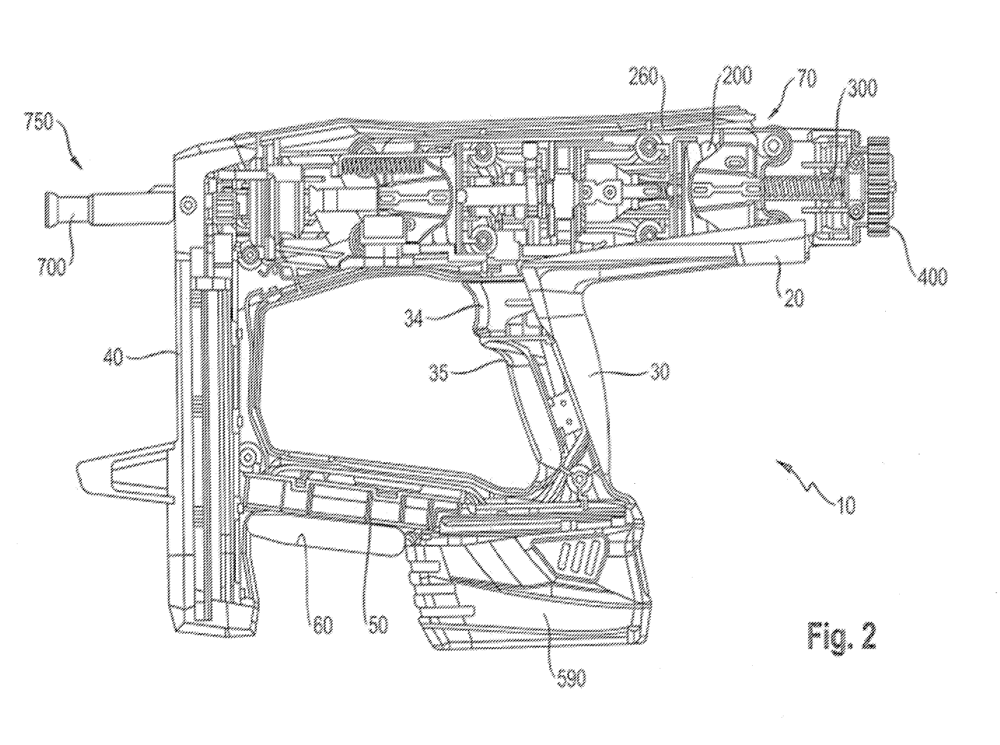

FIG. 2 a side view of a driving-in device with the housing open,

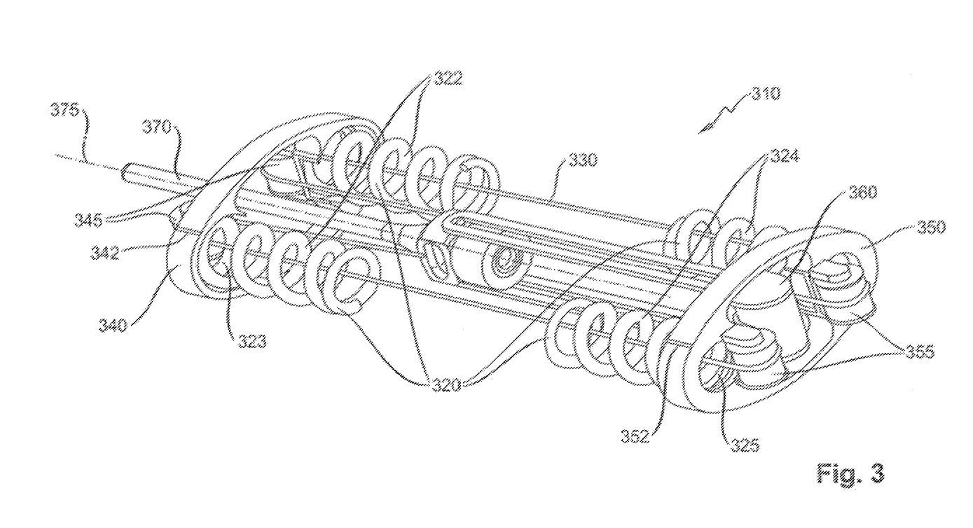

FIG. 3 a perspective view of an energy transfer device,

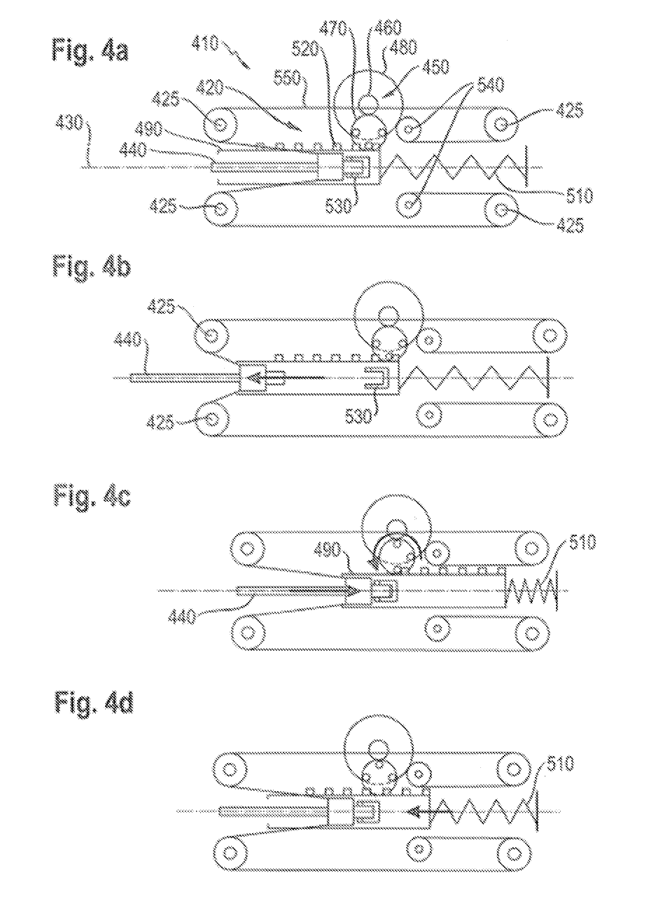

FIG. 4 a schematic representation of a driving-in device,

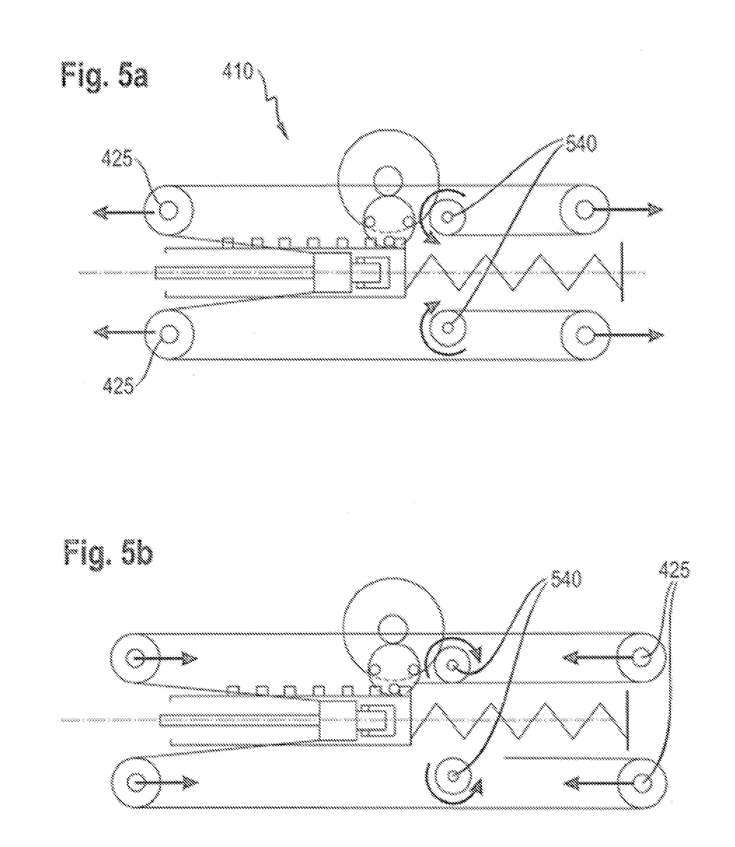

FIG. 5 a schematic representation of a driving-in device,

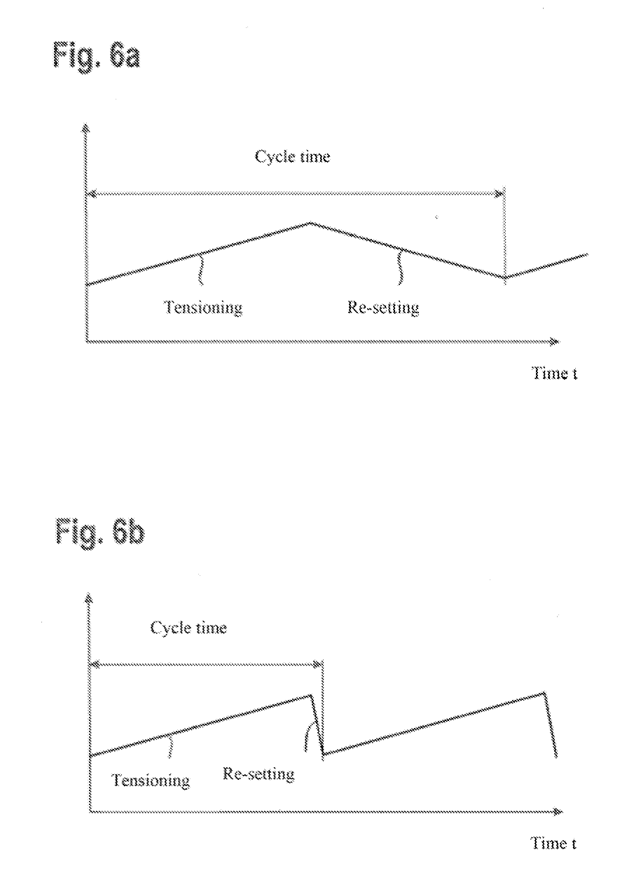

FIG. 6 a schematic representation of a tension cycle. and

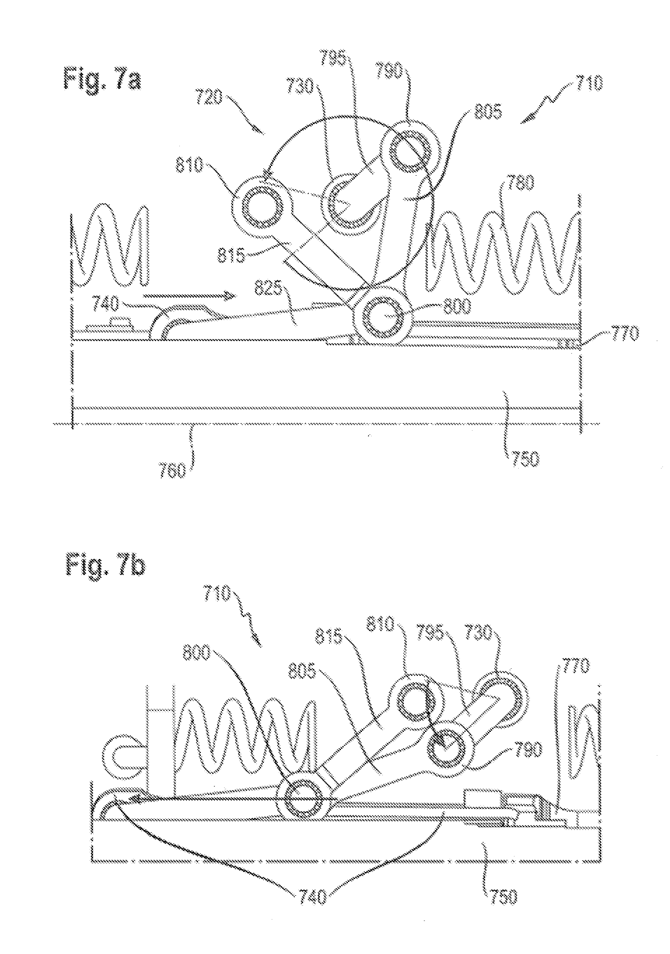

FIG. 7 a partial view of an energy transfer device.

FIG. 1 shows a driving-in device 10 to drive a fixing element such as a nail or bolt into a substrate in a side view. The driving-in device 10 has an energy transfer element, not shown, to transfer energy to the fixing element, and a housing 20, in which the energy transfer element and a driving-in device, also not shown, are housed for the conveyance of the energy transfer element.

The driving-in device 10 also has a handle 30, a magazine 40 and a bridge 50 connecting the handle 30 with the magazine 40. The magazine is not removable. A frame hook 60 for suspension of the driving-in device 10 on a frame or the like and an electrical energy storage device in the form of a rechargeable battery 590 are attached to the bridge 50. There is a trigger 34 on the handle 30 as well as a handle sensor in the form of a hand switch 35. Furthermore, the driving-in device 10 has a guide channel 700 to guide the fixing element and a pressing device 750 to detect a distance between the driving-in device 10 from a substrate, not shown. An alignment of the driving-in device perpendicular to a substrate is facilitated by an alignment aid 45.

FIG. 2 shows the driving-in device 10 with open housing 20. There is a drive device 70 to convey an energy transfer element (concealed in the drawing) in the housing 20. The drive device 70 comprises an electric motor, not shown, to convert electrical energy from the rechargeable battery 590 into rotary energy, a torque transfer device with a gear 400 to transfer torque from the electric motor to a movement transducer in the form of a spindle drive 300, a force transfer device with a pulley 260 to transfer force from the movement transducer to a mechanical energy storage device in the form of a spring 200 and to transfer force from the spring to the energy transfer element.

FIG. 3 shows a perspective view of a force transfer device formed as pulley block 310 to transfer force to a spring 320. The pulley block 310 has a force deflector in the form of a belt 330 and a front roller holder 340 with front rollers 345 and a rear roller holder 350 with rear rollers 355. The roller holders 340, 350 are preferably made in particular of fiber-reinforced plastic. The roller holders 340, 350 have guide rails 342, 352 to guide the roller holders 340, 350 in a housing, not shown, of the driving-in device, in particular in grooves of the housing, whereby tilting is avoided under certain circumstances. The belt 330 is connected to an entrainment element 360 as well as a piston 370, and is positioned above the rollers 345, 355 to form the pulley block 310. The piston 370 is engaged and held in a coupling device, not shown. The piston 370 can basically move back and forth along a set axis 375, on which the coupling device is preferably arranged.

Further, a spring 320 is shown, which has two front spring elements 322 and two rear spring elements 324. The front spring end 323 of the front spring elements 322 are received in the front roller holder 340, while the rear spring ends 325 of the rear spring elements 324 are received in the rear roller holder 350 so that the force of the spring elements 322, 324 can be received by the roller holders 340, 350. The spring elements 322, 324 are supported on their sides facing each other on support rings, not shown. The symmetrical arrangement of the spring elements 322, 324 neutralizes the recoil forces of the spring elements 322, 324, so that the ease of use of the driving-in device is improved. The pulley causes a transmission of a relative speed of the spring ends 230, 240 into a speed of the piston 100 by a factor of two, i.e. a transmission of a speed of each of the spring ends 230, 240 into a speed of the piston 100 by a factor of four.

Each of the spring elements 322, 324 is designed as a coil spring, whose helix defines a cylinder whose volume is arranged outside the set axis, and whose axis of symmetry extends parallel to the set axis, whereby the front spring elements 322 are arranged opposite one another with respect to the set axis 375. Similarly, the rear spring elements 324 are arranged on opposite sides of the set axis 375. The energy transfer element 370 is arranged at the same height as the front spring elements 322 in the axial direction 375. The belt 330 extends inside the spring elements 322, 324, more specifically in the cylinders defined by them, and thus it is possible to save space. To compensate for manufacturing tolerances in the length of the individual spring elements 322, 324, the roller holders 340, 350 are provided with compensation elements, not shown.

FIGS. 4 and 5 respectively show a schematic view of a driving-in device 410, with a mechanical energy storage device, not shown, to store mechanical energy and an energy transfer device 420 to transfer energy from an energy source, not shown, to the mechanical energy storage device. The driving-in device 410 has an energy transfer element 440 that is movable along a set axis 430 between a starting position and a set position in order to transfer energy from the mechanical energy storage device to a fixing element, not shown. Preferably, the mechanical energy storage device is formed as a spring with two opposing ends of the spring that are movable with the help of roller holders 425 in order to tension the spring. Preferably, the spring has two spaced apart and, in particular, mutually supporting spring elements.

The energy transfer device 420 has a first energy supply device to transfer energy from an energy source to the mechanical energy storage device and a second energy supply device different from the first energy supply device to transfer energy from the energy source to the mechanical energy storage device. The first and second energy supply devices together comprise a force deflector in the form of a belt 450, a motor, not shown with a motor output, as well as a gear drive in the form of a sun wheel 460 of a planetary gear 450 of a torque transfer device, not further illustrated.

The first energy supply device further has a first gear output in the form of a ring gear 480 of the planetary gear 450, a free wheel, not shown, an entrainment element 490, and a movement transducer to convert a rotary movement into a linear movement with a rotary drive in the form of the ring gear 480, and a linearly movable linear drive, which has a toothed rack that is formed by an entrainment element 520. The first energy supply device is used to convey the energy transfer element from the set position to the starting position.

Furthermore, the energy transfer device 420 has an entrainment spring 510, the force of which resets the entrainment element as soon as the energy transfer element 440 is held by a coupling device 530 during a tensioning process and the entrainment element is released. During the tensioning process, the entrainment element is moved against the resetting force of the entrainment spring. During the tensioning process, the energy transfer element is conveyed from the set position to the starting position in order to transfer energy to the mechanical energy storage device via a force deflector in the form of a belt 550. In this case, it is sufficient if the entrainment element 490 only abuts the energy transfer element 440 in order to transfer energy to the mechanical energy storage device via the ring gear 480, the toothed rack 520, the entrainment element 490, the energy transfer element 440, the belt 530 and the roller holder 425. For this purpose, the entrainment element 490 is in the form of a rod with a hook.

In contrast, the second energy supply device has a second gear drive in the form of a planetary wheel 470 of the planetary gear 450, a parking brake, not shown, and a take-up reel 540 for winding up the belt 550. The second energy supply device is used to transfer energy to the mechanical energy storage device and to discharge energy from the mechanical energy storage device without moving the energy transfer element.

In FIGS. 4a) to d) a normal operation cycle during the driving in of a fixing element in a substrate is shown. The set direction “forward” is to the left in each case.

In FIG. 4a), the springs are tensioned, the energy transfer element 440 is held by the coupling device 530 in its starting position, and the entrainment element 490 is in its forward-most position. Following the entrainment process, the entrainment device 410 is in the position shown in FIG. 4b). The springs are relaxed, and the energy transfer element 440 is in the set position, in which the entrainment element 490 is abutted against the energy transfer element 440. Then, the energy transfer element 440 is conveyed back by means of the first energy supply device, i.e. through the ring gear 480 and the entrainment element 490, to its starting position in order to tension the springs (FIG. 4c). As soon as the energy transfer element 440 is coupled in the coupling device 530, the entrainment element 490 is released due to missing teeth on the ring gear 480 and moved forward by the entrainment spring 510 (FIG. 4d). This rack gear translates the rotary movement of the planetary gear 450 into a linear movement of the entrainment element 490, whereby the teeth at the end of the tensioned movement are outside due to the missing teeth, so that the entrainment element 490 that is spring-loaded by the entrainment spring 510 springs back to the front position.

In FIGS. 5a) to b), the relaxation and subsequent tensioning of the springs is shown in the case of the unmoved energy transfer element 440, for example, when the driving-in device 410 is turned off and on again. The set direction “forward” is to the left in each case.

As shown in FIG. 5a), when the driving-in apparatus 410 is turned off, the take-up reels, which are connected to one another via a gearing (not shown) for this purpose, are driven by the springs in the direction shown, for which purpose the parking brake is released, so that the energy derived from the springs is supplied to the motor. The motor in this case serves as a motor brake. The energy transfer element 540 remains in its starting position. As soon as the driving-in apparatus 410 is turned on again, the motor drives the take-up reels 540 in the direction shown in FIG. 5b) via the planetary gear 470, so that the springs are tensioned again.

FIG. 6 shows a qualitative representation of a tensioning cycle of known driving-in apparatuses (FIG. 6a) as well as the apparatus according to the invention (FIG. 6b).

For this purpose, the position of a tensioning element of the energy transfer device, for example of an entrainment element over time, is shown during a tensioning cycle. According to FIG. 6a), as much time is necessary for the tensioning of the spring as for resetting the energy transfer element and/or the tensioning element.

According to the present invention, the tensioning element is movable between a relaxed position and a tensioned position and is movable on the path from the tensioned position to the relaxed position at a higher speed than on the path from the relaxed position to the tensioned position (FIG. 6b). With the same driving-in energy and thus the same tensioning time, the entire tensioning cycle can run in a shorter time due to the reduced resetting time so that higher set rates can be achieved. The tensioning element is movable from the relaxed position to the tensioned position in order to transfer energy to the mechanical energy storage device.

FIG. 7 shows a partial view of an energy transfer device 710 for transferring energy to a mechanical energy storage device in the form of a coil spring 780. The energy transfer device 710 has a coupling mechanism 720 with a coupling gear drive 730 and a coupling gear output, which forms a tensioning element 740 in the form of an entrainment element.

The energy transfer device has a motor, not shown, which in order to drive the tensioning element 740 first drives the coupling gear drive 730 to rotate at a essentially constant rotational speed. By means of a guide, the tensioning element is linearly movable back and forth between the left relaxed position in FIG. 7 and the right tensioned position in FIG. 7 in order to convey an energy transfer element 770 that is movable along a set axis 760 between a starting position and a set position from a set position to the starting position when the tensioning element 740 is moved from the tensioned position to the relaxed position. The tensioning element 740 in the form of an entrainment element is reset when the tensioning element 740 is moved from the relaxed position to the tensioned position.

In one embodiment, not shown, the energy transfer element is conveyed from the set position to the starting position when the tensioning element is moved from the tensioned position to the relaxed position. The tensioning element is then reset when the tensioning element is moved from the tensioned position to the relaxed position. In such embodiments, the energy is preferably transferred to the mechanical storage device, whereby the energy transfer element is transferred to its starting position.

The coupling gear 720 has, in addition to the coupling gear drive 730, a first intermediate element 790, a second intermediate element 800 and a mating element 810. The first intermediate element 790 is connected via a first coupling rod 795 to the coupling gear drive 730, so that the first intermediate element 790 describes a circular path about the coupling gear drive 730 and runs at a constant angular velocity. The coupling gear drive 730 and the mating element 810 are fixed to a housing 750 of the energy transfer device 710. The second intermediate element 800 is connected via a second coupling rod 805 with the first intermediate element 790, via a third coupling rod 815 with the mating element 810, and via a fourth coupling rod 825 with the tensioning element 740. Because of the third coupling rod 815, the second intermediate element 800 describes a circular path around the mating element 810, which however does not run at a constant velocity due to the second coupling rod 805. The coupling rods 795, 805, 815, 825 are connected with each other and fixed to the housing elements 730, 810 by means of ball or needle bearings.

The length of the first coupling rod 795 is shorter by a small amount than the distance between the coupling gear drive 730 and the mating element. This results—in the case of uniform movement of the first intermediate element 790—during a large part of the circular path run through by the first intermediate element 790 in a comparatively slow forward movement of the second intermediate element 800 (in FIG. 7a to the right), and during the smaller remaining portion of the circular path, when the first intermediate element 790 passes close to the mating element 810, there is a relatively fast movement of the second intermediate element 800 rearwards (in FIG. 7b to the left). The rotary speed of the motor is preferably set so that the tensioning phase is just sufficient to tension the spring 780, so that a relatively short cycle time is achieved.

1. An apparatus for driving a fixing element into a substrate having a mechanical energy storage device to store mechanical energy and an energy transfer device to transfer energy from an energy source to the mechanical energy storage device, whereby the energy transfer device has a tensioning element that is movable between a relaxed position and a tensioned position, whereby the tensioning element can be moved on the path at a higher speed from the tensioned position to the relaxed position than it can be moved on the path from the relaxed position to the tensioned position.

2. An apparatus according to claim 1, whereby the tensioning. element for the transfer of energy to the mechanical energy storage device can be moved from the relaxed position to the tensioned position.

3. An apparatus according to claim 1, whereby the energy transfer device has a motor to drive the tensioning element.

4. An apparatus according to claim 3, whereby the motor, when driving the tensioning element along the path from the tensioned position to the relaxed position, moves with the same speed as when driving the tensioning element along the path from the relaxed position to the tensioned position.

5. An apparatus according to claim 1, whereby the energy transfer device has a coupling gear with a coupling gear drive and a coupling gear output, whereby the coupling gear output drives or forms the tensioning element.

6. An apparatus according to claim 5, whereby the coupling gear drive is driven by the drive motor.

7. An apparatus according to claim 1, whereby the tensioning element is linearly movable back and forth between the relaxed position and the tensioned position.

8. An apparatus according to claim 1, which furthermore has an energy transfer element that is movable along a set axis between a starting position and a set position in order to transfer energy from the mechanical energy storage device to the fixing element.

9. An apparatus according to claim 8, whereby the energy transfer element is conveyed from the set position to the starting position when the tensioning element is moved from the relaxed position into the tensioned position.

10. An apparatus according to claim 8, whereby the energy transfer element is conveyed from the set position to the starting position when the tensioning element is moved from the tensioned position to the relaxed position.

11. An apparatus according to claim 1, whereby the energy transfer device has an entrainment element moved by or comprising the tensioning element that can be engaged with the energy transfer element to move the energy transfer element from the set position to the starting position.

12. An apparatus according to claim 11, whereby the entrainment element is reset when the tensioning element is moved from the relaxed position to the tensioned position.

13. An apparatus according to claim 11, whereby the entrainment element is reset when the tensioning element is moved from the tensioned position to the relaxed position.

14. An apparatus according to claim 1, whereby a mechanical energy storage device is provided to store potential energy, and has in particular a spring, in particular a coil spring.
